(19) United States
(12) Patent Application Publication
(10) Pub. No.: US 2025/0079936 A1
(43) Pub. Date: Mar. 6, 2025

(54) Electromagnetic Combo Machine and Method For Use in Downhole Applications

(71) Applicant: MS Directional, LLC, Conroe, TX (US)

(72) Inventors: Libo YANG, Katy, TX (US); Arnold FENOCCHI, London (GB); Peter Nicholas WELLS, Houston, TX (US); Nobuyoshi NIINA, Kanagawa (JP)

(73) Assignee: MS Directional, LLC, Conroe, TX (US)

(21) Appl. No.: 18/458,313

(22) Filed: Aug. 30, 2023

(51) Int. Cl. H02K 7/18; H02K 17/16

(52) U.S. Cl. CPC H02K 7/1823; H02K 17/16

(57) ABSTRACT

The invention provides a compact electromagnetic (EM) combo machine formed of a generator portion and a motor portion providing electrical power generation and actuation of a rotating or displacing shaft. The EM combo machine can be immersed in a flowing fluid. A turbine coupled to the generator portion can rotate a rotor on the generator portion. The generator portion that generates electrical power can be electrically directly coupled to the motor portion that actuates devices and can be within a single package. The speed of the motor portion can be controlled with a braking technique that includes a controlled electrical load. Any required relative rotational speed in revolutions per minute can be achieved by optimizing the number of poles of the motor portion compared to the generator portion. The possible combinations of radial flux and an axial flux designs for the EM combo machine provides added flexibility.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure generally relates to electrical power generation with direct electrical connections to a motor portion. More specifically, the disclosure relates to electrical power generation from a particle laden flowing fluid and direct control of a motor portion for rotatable or liner actuation, as examples, for use at least in oilfield downhole, mining, and construction applications.

### DESCRIPTION OF THE RELATED ART

In certain environments, location specific power is needed to operate instruments, tools, and other equipment. Space is often a premium and compact power is mandatory. Oil field downhole operations provide one example. Drilling an oilfield well proceeds through strata tens of thousands of feet often starting with basketball size diameter tubing progressing down to tennis ball size diameter tubing as well depth increases. Power is needed often downhole in the well at the deepest levels. The industry is challenged to support power at those depths and often rely on battery power that must be pulled out of the well for replacement or recharging. Another example is mining applications that have similar challenges with long mine shafts.

An alternative is to generate the power downhole, such as in a formation measurement and logging while drilling operations. A typical localized power generator is used in such local applications. The typical method makes use of separate electric machines, such as a stand-alone permanent magnet (PM) electrical power generator and a stand-alone PM motor, immersed in a pressure-balanced hydraulic oil. Drilling fluid known as “mud”, laden with particulates, circulates from a surface elevation through an internal volume of tubular members coupled to a drill bit to wash bits of rock and other materials from the leading edges of a drill bit and flow such debris back to the surface in an annulus around the tubular members in the well bore formed by the drilling bit. A face seal forms a dynamic seal between the mud and internal, pressure-compensating, hydraulic oil of the generator.

FIG. 1A is a schematic side view of a typical stand-alone, permanent magnet power generator and stand-alone, permanent magnet motor for operating a downhole device, such as a Rotary Steerable System (RSS) tool having moving components or other devices. FIG. 1A and other like figures herein are shown in an upper half schematic with a lower half schematic (not shown) generally being symmetrical about a longitudinal axis 5. FIG. 1B is a schematic end view of a valve portion of the RSS tool of FIG. 1A. For illustration, a typical RSS tool contains multiple functional sections. Generally, during operation a fluid-driven, downhole generator powers a separate motor that rotates a shaft coupled a rotary valve. The rotary valve distributes internal high-pressure mud flow to pads in a systematical manner to steer the tool in a wellbore. The high-pressure mud flow pushes and opens the pads systematically, providing a mechanical displacement, such as a pad extrusion against a wellbore wall to push a drill bit attached to the RSS tool in an angular direction to the uphole wellbore.

More specifically, the RSS tool includes two independent EM components such as a PM alternator 14 and a PM motor 16. Drilling mud flow 1 rotates an impeller 13, which is connected to a rotor 27 of the PM alternator 14. Electrical power generated by the PM alternator 14 is regulated by electronics 15. The regulated power is used to function the electronics 15. It is also used to run the PM motor 16. A centralizer 11 is keyed to both an electronics housing 12 and a collar 10. Hence, when the collar 10 is rotated in a clockwise direction 2, the electronics housing 12 is also rotated at the same rotational speed in the same direction 3. If the collar 10 is rotated in a clockwise direction at an X rpm from a rotary table, a rotary valve 18 must be rotated at the X rpm in a counterclockwise direction 4 systematically, so that the RSS tool can bias the drilling trajectory. That position is known as the geo-stationary position. The PM motor 16 is used and controlled to rotate a drive shaft 17, which is connected to a rotor 19 of a rotary valve 18. The rotor 19 slides on a stator 20 and controls flow going to the pads 23-26. The stator 20 is attached and keyed to the collar 10. The schematic shows the internal high-pressure mud flows to a feedbore 21 connected to the pad 23, but it does not flow to the feedbore 22 connected to the pad 25. No high-pressure drilling mud flows to other pads (pad 24, pad 25, and pad 26) through the rotary valve 18.

Thus, the typical system and method makes use of separate electric machines, such as a stand-alone PM electrical power generator and a stand-alone PM motor immersed in a pressure-balanced hydraulic oil. The typical system has two steps to rotate a drive shaft for a downhole device, because the power generator and the motor are independent. Electrical power is generated with a turbine alternator, and then the power is regulated with separate active electronic components to the proper frequency, phase, and voltage. The regulated electrical power is used to operate the separate motor. In a field where size is critical, reducing size and complexity can have a major impact.

Further complications are caused by a face seal that forms the rotational seal between the external mud and internal, pressure-compensating, hydraulic oil for the generator and the motor. If the face seals leaks, the system can fail resulting in significant expense to pull the defective system out of the wellbore, replace it, and reinsert the replacement to resume operation.

Existing patents show applications of a typical system such as: U.S. Pat. No. 4,713,567, entitled “Electromagnetic Brake Device for a Sports Training Apparatus”; U.S. Pat. No. 5,265,682, entitled “Steerable Rotary Drilling Systems”; U.S. Pat. No. 5,517,464, entitled “Integrated Modulator and Turbine-Generator for a Measurement While Drilling Tool”; U.S. Pat. No. 5,706,905, entitled “Steerable Rotary Drilling Systems”; U.S. Pat. No. 7,002,261, entitled “Downhole Electrical Submersible Power Generator”; U.S. Pat. No. 7,133,325, entitled “Apparatus and Method for Generating Electrical Power in a Borehole”; U.S. Pat. No. 7,504,963, entitled “System and Method for Providing Electrical Power Downhole”; U.S. Pat. No. 9,863,238, entitled “Submersible Electrical Machine and Method”; U.S. Pat. No. 10,167,702, entitled “Electrical Power Generation System”; U.S. Pat. No. 11,035,205, entitled “Modular Downhole Generator”; US 2004/0140726, entitled “Downhole Torque Generator”; US 2004/0144570, entitled “Downhole Torque-Generating and Generator portion Combination Apparatus”; and US 2015/0091306, entitled “System and Method for Downhole Power Generation using a Direct Drive Permanent Magnet Machine:.

Therefore, there remains a need for a simpler, more compact, and more reliable system that includes electrical power generation coupled with a motor.

### BRIEF SUMMARY OF THE INVENTION

The invention provides a compact electromagnetic (EM) combo machine providing generation of an electrical power from a fluid flow and actuation of a rotating or displacing shaft. An EM combo machine can be immersed in a flowing fluid. The fluid flow can drive rotation of an impeller on a turbine that in turn can rotate a rotor on the generator portion to generate electrical power. The generator portion can be electrically directly coupled with a motor portion as a driver for tools and other devices to form an EM combo machine that performs generation of electrical power and actuation within a single package. In some embodiments, the generator portion and motor portion are integrated to form an electromagnetic machine as a subcategory of the EM combo machine. The speed of the EM combo machine output shaft can be controlled and fine-tuned with a braking technique. The braking technique can include a controlled electrical load to control the power from the generator portion to the motor portion. The controlled electrical load can be a variable resistor, a pulse width modulator, and other devices as would be known to those with skill the art. The structure and electronics circuit allow control of a rotational speed or displacement and orientation of the motor portion as expected in a traditional setup, but with a much simplified control system and compact system compared to a typical system. The simplified electronics circuit helps improve the system reliability. Any required relative rotational speed in revolutions per minute or displacement can be achieved by optimizing the number of poles of the motor portion compared to the generator portion. The possible combinations of radial flux designs and axial flux designs for the EM combo machines can provide added flexibility for applications.

The inventive EM combo machine can feasibly work in many flow environments, including those environments with drilling-mud or other particulate-laden fluids, by accommodating the peripheral designs accordingly. As an example, the EM combo machine can be used for a downhole device, providing a rotation of a shaft in a controlled manner, such as for a Rotary Steerable System (RSS) tool for a mechanical displacement such as a pad extrusion to push against the downhole formation with the extruded pad of the RSS tool to steer drilling operations. Another example is in a mud modulator that uses a rotating shaft to create a pressure wave within the drill pipe for telemetry to send data uphole. Similarly, the mining and construction industries or other industries requiring a power generation and actuation device and having a fluid flow such as a mud or a particulate laden fluid can benefit from the invention. Further, several forms and combinations of the EM combo machine are possible depending on the required performance and size restrictions. The EM combo machine can have various features to reduce or prevent mud packing and accumulation of magnetic particles in between the rotor and stator for power generation. An induction EM combo machine (that is, without substantive permanent magnets) can have a great advantage when it is used in drilling mud containing ferromagnetic particles. Without the permanent magnets, ferromagnetic particles in the surrounding flowing fluid are less likely to be caught and accumulate near the rotor, which helps prevent jamming and seizing of the rotor, resulting in improved tool reliability. These particles wash away when the EM combo machine stops rotating when the fluid flow is below the operating range and the magnetism dissipates.

The disclosure provides an electromagnetic combo machine, comprising: a generator portion; and a motor portion electrically directly coupled to the generator portion.

The disclosure further provides a method of actuating a device, comprising: providing power to an electromagnetic combo machine having a generator portion electrically directly coupled to motor portion; and actuating the device with the electromagnetic combo machine.

### BRIEF DESCRIPTION OF THE SEVERAL VIEWS OF THE DRAWINGS

FIG. 1A is a schematic side view of a typical stand-alone, permanent magnet power generator and stand-alone, permanent magnet motor for operating a downhole device, such as a Rotary Steerable System (RSS) tool or other device.

FIG. 1B is a schematic end view of a stator of FIG. 1A.

FIG. 2 is a schematic view of an example of an electromagnetic (“EM”) combo machine of the present invention having a permanent magnet generator portion electrically directly coupled with an induction motor portion and having a controlled electrical load for speed control and/or positional control.

FIG. 3 is a schematic of an equivalent circuit of the generator portion and motor portion of FIG. 2.

FIG. 4 is a schematic of an electrical circuit of the generator portion and motor portion of FIG. 2.

FIG. 5 is a schematic of an example of a chart of torque response relative to rotational speed of a typical induction machine when used as a generator portion or a motor portion, depending on the rotational speed of the machine.

FIG. 6 is a schematic of an example of an equivalent electrical circuit for the induction machine represented in FIG. 5.

FIG. 7 is a schematic of example of a rotor construction having a double squirrel cage, such as for a motor portion.

FIG. 8 is a graph of torque relative to slip illustrating modes of operation for the double squirrel cage rotor embodiment of FIG. 7 . . .

FIG. 9 is a schematic graph of torque for the induction motor portion relative to rotational speed for different levels of rotor resistance and includes maximum slip speed indications for the motor portion of FIG. 2.

FIG. 10A is a schematic graph of an arbitrary speed demand profile relative to time for the EM combo machine of FIG. 2.

FIG. 10B is a simulated schematic graph of an exemplary induction motor portion speed of the EM combo machine following the speed demand profile relative to time of FIG. 10A.

FIG. 10C is a simulated schematic graph of an exemplary PM generator portion speed of the EM combo machine with a PM generator portion due to the speed demand profile over time as adjusted for a pole count ratio between the generator portion and the motor portion.

FIG. 11 is a schematic of another example of an EM combo machine having an induction generator portion coupled with an induction motor portion with a controlled electrical load for speed control and/or positional control, and a reactive power source for the induction generator portion.

FIG. 12A is a schematic graph of an arbitrary speed demand profile relative to time for the EM combo machine of FIG. 11.

FIG. 12B is a simulated schematic graph of an exemplary induction motor portion speed of the EM combo machine of FIG. 11, with a stiff torque-speed (slip) characteristic squirrel-cage rotor design of the induction generator portion, following the speed demand profile relative to time of FIG. 12A.

FIG. 12C is a simulated schematic graph of an exemplary induction generator portion speed of the EM combo machine of FIG. 11 with the induction generator portion due to the speed demand profile over time of FIG. 12A, as adjusted for a pole count ratio between the generator portion and the motor portion and with a stiff torque-speed-slip characteristic squirrel-cage rotor design.

FIG. 13A is a schematic graph of an arbitrary speed demand profile of the EM combo machine relative to time as the same demand profile as in FIG. 12A, but for a less stiff torque-speed characteristic of the induction generator portion.

FIG. 13B is a simulated schematic graph of an exemplary induction motor portion speed of the EM combo machine following the speed demand profile relative to time of FIG. 13A with a less-stiff torque-speed-slip characteristic squirrel-cage rotor design.

FIG. 13C is a simulated schematic graph of an exemplary induction generator portion speed of the EM combo machine with the induction generator portion following the speed demand profile over time of FIG. 13A, as adjusted for a pole count ratio between the generator portion and the motor portion with a less-stiff torque-speed-slip characteristic squirrel-cage rotor design.

FIG. 14 is a schematic of an embodiment of an EM combo machine having a radial flux oriented generator portion and motor portion.

FIG. 15 is a schematic of another embodiment of an EM combo machine having an axial flux generator portion and motor portion.

FIG. 16 is a schematic of another example of an EM combo machine having a single-shaft system with permanent magnet generator portion having an output drive shaft of a motor portion to form an EM machine.

FIG. 17A is a schematic graph of an arbitrary speed demand profile relative to time for the EM machine of FIG. 16.

FIG. 17B is a simulated schematic graph of an exemplary drive shaft speed of the EM machine following the speed demand profile relative to time of FIG. 17A.

FIG. 17C is a simulated schematic graph of an exemplary PM generator portion speed of the EM machine controlling a variable, resistive braking load, with the generator portion following the speed demand profile over time of FIG. 17A.

FIG. 18 is a schematic of another embodiment of an EM combo machine similar to the embodiment in FIG. 16 forming an EM machine, but having an induction generator portion.

FIG. 19 is a schematic of another embodiment of an EM machine having a low RPM single-shaft system schematically illustrated in FIGS. 16 and 18.

FIG. 20 is a schematic of another example of an EM combo machine having an induction generator portion coupled with an induction motor portion with a controlled electrical load for speed control and/or positional control, a reactive power source, and a starter circuit for the induction generator portion.

FIG. 21A is a schematic of an embodiment of a PM configuration for a generator portion and/or motor portion (or an EM machine having both functions) having a radial flux topology with an external rotor and an internal stator.

FIG. 21B is a schematic of an embodiment of an induction configuration for a generator portion and/or motor portion (or an EM machine) having a radial flux topology with an external rotor and an internal stator.

FIG. 22A is a schematic of an embodiment of a PM configuration for a generator portion and/or motor portion (or an EM machine) having a radial flux topology with an internal rotor and an external stator, as an alternative to the external rotor and internal stator configuration in FIGS. 21A and 21B.

FIG. 22B is a schematic of an embodiment of an induction configuration for a generator portion and/or motor portion (or an EM machine) having a radial flux topology with an internal rotor and an external stator.

FIG. 23A is a schematic of an embodiment of a PM configuration for a generator portion and/or motor portion (or EM machine) having an axial flux topology with a stator longitudinally adjacent a rotor.

FIG. 23B is a schematic of an embodiment of an induction configuration for a generator portion and/or motor portion (or EM machine) having an axial flux topology with a stator longitudinally adjacent a rotor.

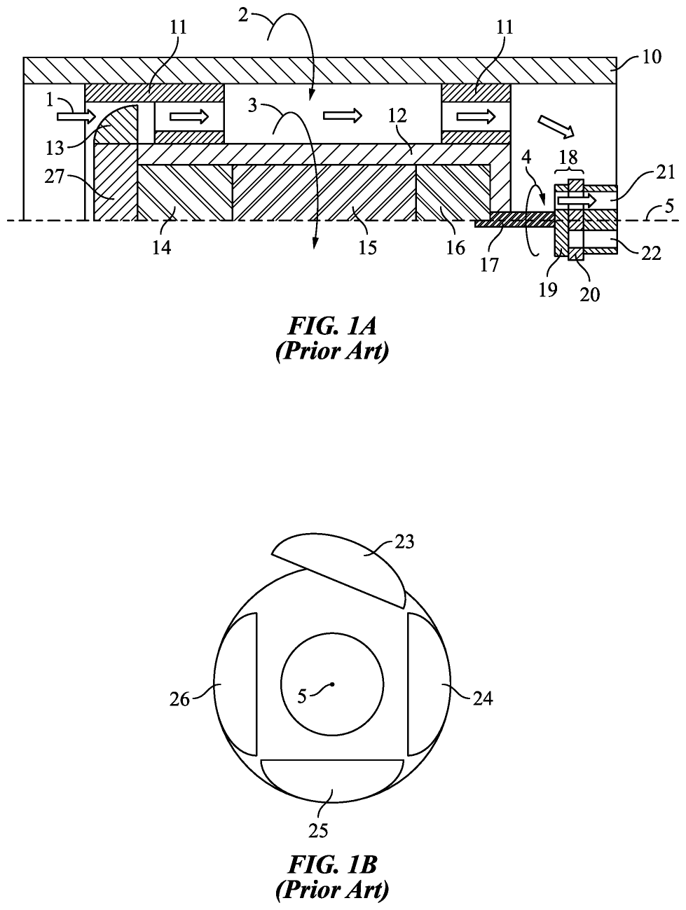

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The terms “top”, “up”, “upper”, “upward”, “bottom”, “down”, “lower”, “downward”, and like directional terms are used to indicate the direction relative to the figures and their illustrated orientation and are not absolute relative to a fixed datum such as the earth in commercial use. The term “inner,” “inward,” “internal” or like terms refers to a direction facing toward a center portion of an assembly or component, such as longitudinal centerline of the assembly or component, and the term “outer,” “outward,” “external” or like terms refers to a direction facing away from the center portion of an assembly or component. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unitary fashion. The coupling may occur in any direction, including rotationally. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. Some elements are nominated by a device name for simplicity and would be understood to include a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. As such, the use of the term “exemplary” is the adjective form of the noun “example” and likewise refers to an illustrative structure, and not necessarily a preferred embodiment. Element numbers with suffix letters, such as “A”, “B”, and so forth, are to designate different elements within a group of like elements having a similar or related structure or function, and corresponding element numbers without the letters are to generally refer to one or more of the like elements. Any element numbers in the claims that correspond to elements disclosed in the application are illustrative and not exclusive, as several embodiments may be disclosed that use various element numbers for like elements.

The invention provides a compact electromagnetic (EM) combo machine formed of a generator portion and a motor portion providing electrical power generation and actuation of a rotating or displacing shaft. The EM combo machine can be immersed in a flowing fluid. A turbine coupled to the generator portion can rotate a rotor on the generator portion. The generator portion that generates electrical power can be electrically directly coupled to the motor portion that actuates devices and can be within a single package. The speed of the motor portion can be controlled with a braking technique that includes a controlled electrical load. Any required relative rotational speed in revolutions per minute can be achieved by optimizing the number of poles of the motor portion compared to the generator portion. The possible combinations of radial flux and an axial flux designs for the EM combo machine provides added flexibility.

EM Combo Machine with PM Generator Portion and Induction Motor Portion

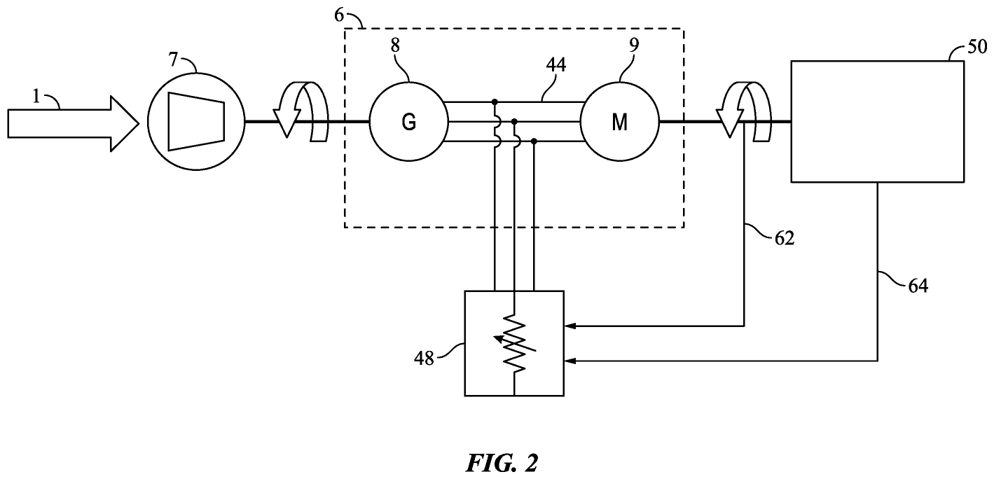

FIG. 2 is a schematic view of an example of an electromagnetic (“EM”) combo machine of the present invention having a permanent magnet generator portion electrically directly coupled with an induction motor portion and having a controlled electrical load for speed control and/or positional control. The electrically directly coupling is intended to mean that no active electronics is required to connect the generator portion to the motor portion, which can provide lower cost and more efficiency. This ability is in stark contrast to traditional electrical power systems having multiple electrical generators that may be miles away connected to an electrical grid that need circuitry not only for voltage regulation, but also frequency and phase modulation from the multiple sources for the motor. Several embodiments herein illustrate the generator portion separate from the motor portion in a schematic depiction. However, the generator portion and the motor portion can be in a single housing and even can share the same stator. The generator portion and motor portion can have the same or different numbers of poles for incremental speed control of the motor portion and/or positional control of a device, and further speed and/or positional control with a controlled electrical load. The controlled electrical load can be a variable resistor, a pulse width modulator, and other load created devices that can be varied in value with a varied input, as would be known to those with skill the art.

In at least some embodiments, the EM combo machine can be immersed in flowing conductive fluid. The fluid can flow through a rotatable turbine and around and even through portions of the EM combo machine, as described herein, to provide rotational power through the turbine to a generator portion. For example, the fluid can flow between a stator and a rotor of the EM combo machine.

In at least one embodiment, drilling mud 1 flows through an impeller of a turbine 7 attached to a rotor of a generator portion 8, causing the rotor to rotate. The generator portion can be a permanent magnet (PM) design or an induction design. In at least one embodiment, a PM rotor induces an EMF (voltage) in stator windings as the rotor rotates. This EMF drives currents in an electronic circuit, such that mechanical power from the turbine is converted to electrical power in the generator portion 8, which is shared through a direct electrical coupling 44 to a motor portion 9. The motor portion 9 is defined broadly and includes not only motors with stators and rotors having a rotatable shaft, but also linear actuators that move linearly instead of rotationally. The motor portion can be a permanent magnet design, an induction design, or a combination. The direct electrical coupling 44 can be in the form of an electrical bus. The motor portion 9 can rotate or otherwise actuate a device 50. A controlled electrical load 48, coupled generally in parallel to the electrically directly coupled generator portion and motor portion can be used for movement control for the motor portion (and thereby device rotational speed or positional control for the device). The controlled electrical load can be used to absorb excess power from the generator portion to regulate motor portion speed or device position. In at least some embodiments, a speed input 62 of the motor portion can be used to adjust the controlled electrical load 48 to maintain the motor portion speed fairly constant or varied as desired under various loads. The speed input can be used to control the motor portion by a speed error, such as a difference between a current motor speed and a desired motor speed. In at least some embodiments, a positional input 64 of the device, such a position of a tool or tool extension, can be used to adjust the controlled electrical load 48 to maintain a position or actuate the device to a desired position. The positional input can be used to control the motor portion by a positional error, such as a difference between a current device position and a desired device position. The excess generated electrical power can also be used by other electronics in the downhole tools.

In an example of an embodiment, using accurate machine parameters, the EM combo machine can be modelled as a 2-pole, PM generator portion 8 electrically directly coupled to a 10-pole induction motor portion 9. The PM generator portion is directly coupled to and driven by mud or other fluid flowing over the turbine 7 providing, in this case, constant torque, while the induction motor portion is used for positioning the device 50, such as an RSS tool control valve. The controlled electrical load 48, fed through a bridge rectifier and controlled by a pulse width modulator (“PWM”, also known as a chopper) can be used to apply a load to the PM generator portion, thereby controlling its speed and output frequency, by dumping excess power from the turbine. This speed control of the PM generator portion 8 through the controlled electrical load 48 indirectly controls the speed of the induction motor portion 9, which exhibits some slip from the synchronous frequency on the electrical bus between the two machines and the controlled electrical load.

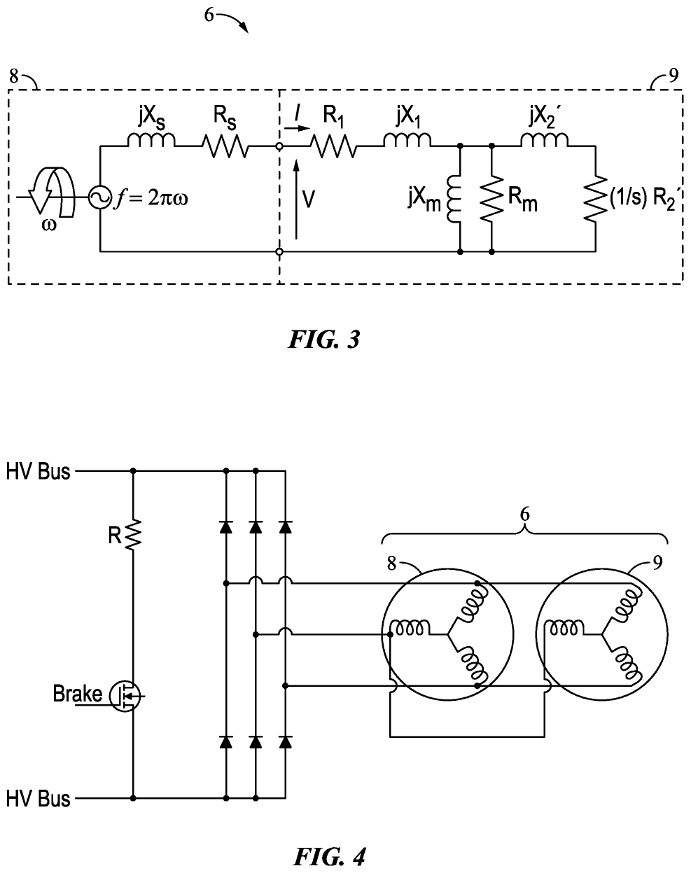

FIG. 3 is a schematic of an equivalent circuit of the generator portion and motor portion of FIG. 2. The PM generator portion can be a constant-magnetic-field machine due to the fixed permanent magnets, and consequently has an output EMF (voltage V) that is directly proportional to its operating rotational speed @, so that V is proportional to a constant k and the frequency f where V/f is proportional to k. This characteristic ideally suits the induction motor portion which can be characterized as a requiring a constant ratio of supply voltage V to supply frequency f. An induction motor portion can be modelled, as shown in FIG. 3, by an equivalent circuit where the impedances are dominated by inductive reactance, X_{L}=ω_{L}, where ω is the operating frequency in rad·s⁻¹ and equals 2πf, where f is the frequency in Hz, and L is the inductance. I is proportional to V/jX that can be written as V/j.2πf.L. As the frequency f varies, the supply voltage V must vary proportionally to the supply frequency f to maintain the required operating current (and torque output of the machine), so that V/f is constant. This matches the characteristic output of the PM generator portion, such that the two machines can be electrically directly coupled to each other without the need of additional control circuits. The controlled electrical load (not shown in the equivalent circuits) is added purely to control the speed of the motor portion and hence, supply frequency f, by absorbing excess power from the turbine.

FIG. 4 is a schematic of an electrical circuit of the generator portion and motor portion of FIG. 2. As shown in the circuit diagram below, the two electric machines, generator portion and motor portion, are electrically directly coupled to each other. The required torque characteristic from the motor portion is derived through the design of its rotor resistance, such as with squirrel cage rotor bars or equivalent for an axial version. The motor portion speed is primarily adjusted through controlling the generator portion frequency f,-via the rotational speed w, with the controlled electrical load, but the rotor-conductor-bar design of the motor portion will determine at what slip the motor portion operates, depending on load, which can range between a near-synchronous speed down to a zero speed.

EM Combo Machine with Induction Generator Portion and Induction Motor Portion

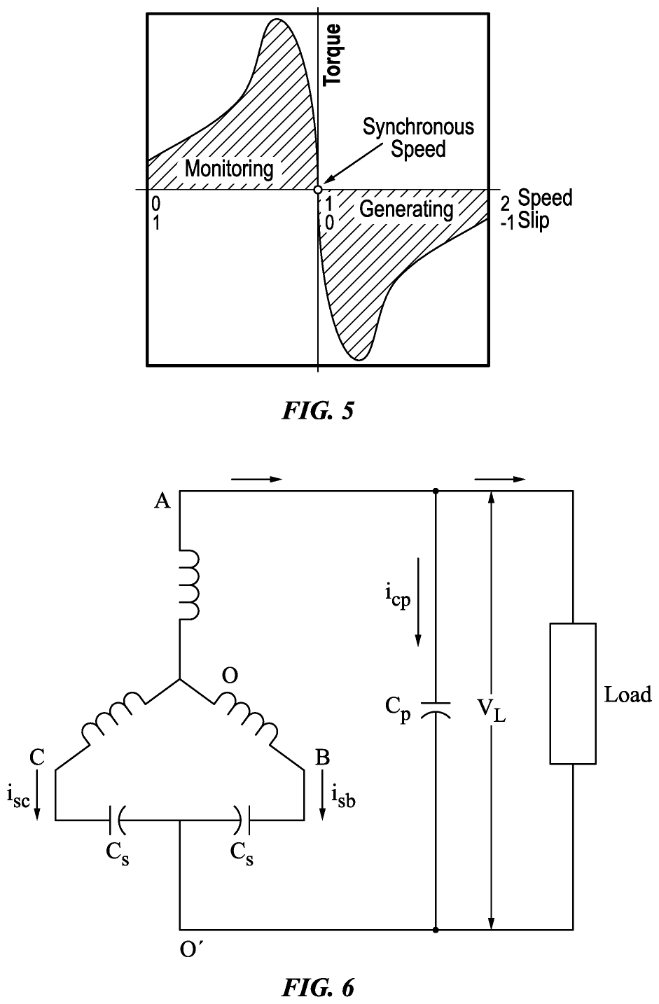

FIG. 5 is a schematic of an example of a chart of torque response relative to rotational speed of a typical induction machine when used as a generator portion or a motor portion, depending on the rotational speed of the machine. The method of this induction machine is very similar to one described above: a PM generator portion+induction motor portion. The PM generator portion above is simply substituted with another induction machine, operating as a generator portion. The kinetic energy is converted to the electrical power by the induction generator portion and the speed of the induction motor portion is controlled, as before, by drawing excess power from the generator portion through a variable, resistive braking load.

This graph shows the typical Torque (y-axis) vs Speed (x-axis) characteristics of an induction machine for the speed range from 0 to 2×synchronous speed, with synchronous speed equaling a value of 1. If the rotor is driven slower than synchronous speed, then the torque becomes positive in a region of a positive slip, where the drive torque is provided by the induction machine rather than applied to the induction machine and the induction machine acts as a motor portion. If the rotor is driven faster than synchronous speed, then the torque becomes negative in a region of a negative slip, where the drive torque is applied to the induction machine rather than provided by the induction machine, and the induction machine changes from being a motor portion to a generator portion.

FIG. 6 is a schematic of an example of an equivalent electrical circuit for the induction machine represented in FIG. 5. A major difference is that the rotor of the induction machine does not contain permanent magnets and a squirrel cage is used instead. It allows no magnetic flux field during no flow or a little flow. Hence, ferromagnetic particles do not accumulate and bond on the rotor case. Without the permanent magnets, the device is expected to have a higher reliability and better maintainability.

To operate as a generator portion, an induction machine requires reactive power to be supplied to provide the magnetization current. The required reactive power, usually, can be supplied to the machine when connected to a main power-grid. However, in a stand-alone configuration, an alternative method is required. One alternative is the use of capacitors to provide this reactive power. For example, a bank of three capacitors for a 3-phase device can be used that are rated for the operating voltage and temperature, including environmental conditions. Other options are to provide a small, low intensity, permanent magnet or a small power pulse to the windings to kick start the electrical power generation.

### Device Pole Numbers

In both the PM generator portion and induction generator portion embodiments, the ratio of pole numbers between the generator portion and the motor portion helps define the operating rotational speed difference between the input turbine and the output drive. This relational difference is particularly determinative if both portions are permanent magnet (PM) machines, because their speeds will be synchronized to the bus frequency between them. However, the use of an induction machine for the motor portion permits a less rigid relationship between turbine and output speeds (analogous to a vehicle with a manual gearbox with a clutch compared to a torque-converter automatic gearbox). Hence, the required speed differences with an inductive motor portion can be achieved somewhat irrespective of pole numbers and operating speed of the PM generator. This flexibility is due to the slip characteristics of the induction motor portion, where torque is produced at less than synchronous speed, according to a torque-speed profile, determined by the motor portion's rotor design.

If the system is designed around two induction machines, one as a generator portion and the other as a motor portion, there is even less dependence of machine speed upon the bus frequency and it is possible to design a system whereby the required speed difference between turbine and output drive (such as 10:1) can be achieved with two machines of similarly low pole counts. This dramatically aids the manufacturing of the machines, when it is difficult to construct a small machine with a high number of poles.

Operation of PM Generator Portion with Induction Motor Portion

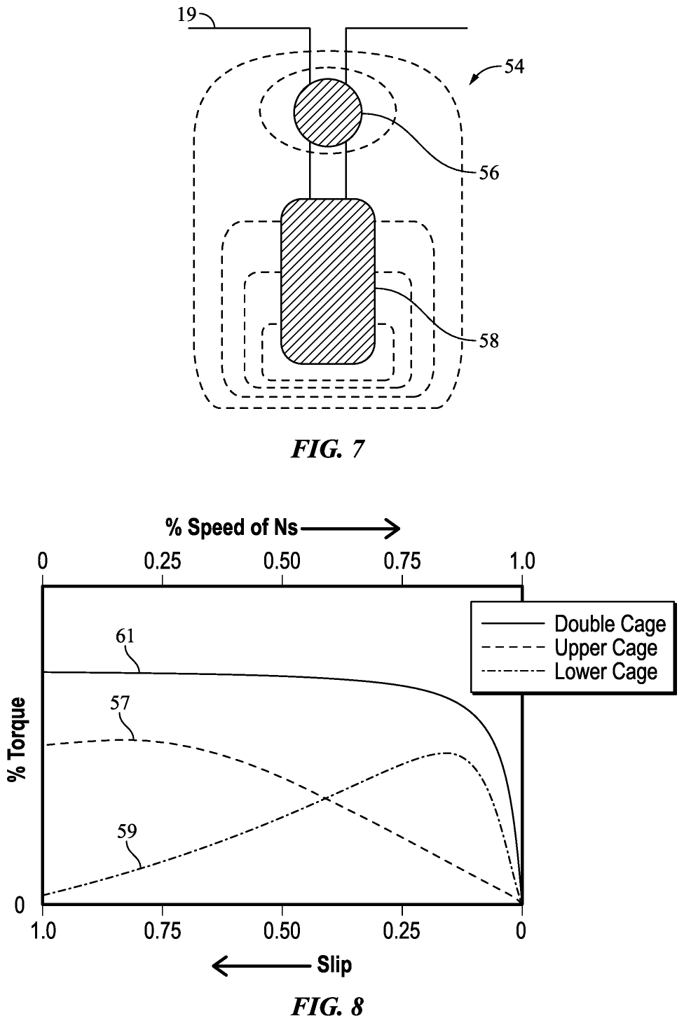

FIG. 7 is a schematic of example of a rotor construction having a double squirrel cage, such as for a motor portion. FIG. 8 is a graph of torque relative to slip illustrating modes of operation for the double squirrel cage rotor embodiment of FIG. 7. The design of the induction motor portion can be tailored to provide the desired torque characteristic according to machine slip (a fractional difference between synchronous speed, Ns, and actual speed). This provision is typically achieved through the design of the rotor bars in a double squirrel cage 54 as a type 20) of squirrel cage for a magnetic flux element 28 (described below in more detail) of the motor portion rotor. A first cage 56, shown as an upper cage, of the double squirrel cage can be constructed with a high resistance, resulting in a low magnetic flux during operation. The first cage would therefore have a torque curve 57 with a high starting torque at low speed with a significant slip that slopes downward as speed increases, as shown in FIG. 8. Conversely, a second cage 58, shown as a lower cage, of the double squirrel cage can be constructed with a 25 low resistance, resulting in a high magnetic flux during operation. The second cage would therefore have a torque curve 59 with a low starting torque at low speed with a significant slip that slopes upward as the speed increases with a steep fall off as it approaches a higher speed with little slip. The second cage is in magnetic proximity to the first cage and together the cages generate a combined magnetic flux field. The proximity of the cages results in a combined double squirrel cage torque curve 61 that shows a generally constant torque for much of the available speed and slip profile

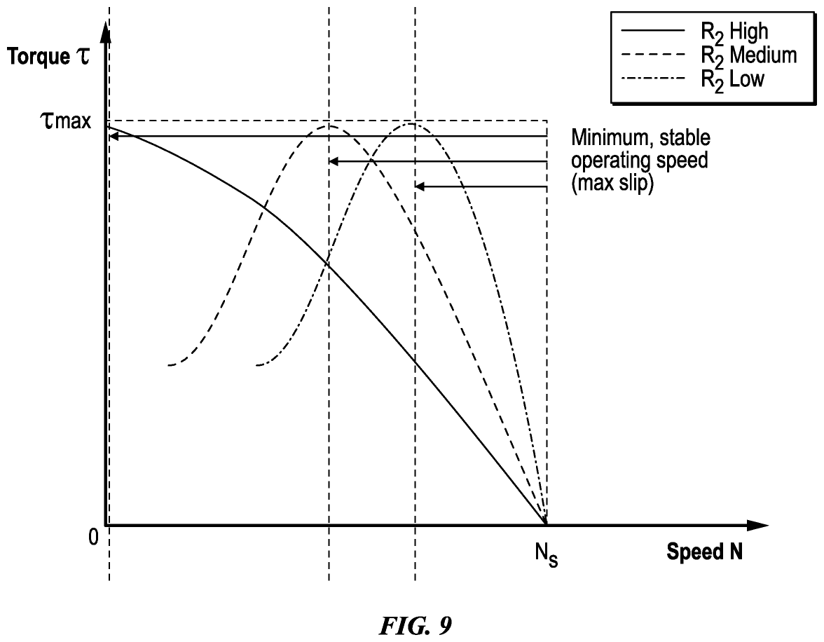

FIG. 9 is a schematic graph of torque for the induction motor portion relative to rotational speed for different levels of rotor resistance and includes maximum slip speed indications for the motor portion of FIG. 2. The torque-speed characteristic of an induction motor portion (or other induction machines described herein) depends on the rotor resistance R2, which is the apparent electrical resistance of the squirrel-cage bars. A high value of R2 can provide a stable operating point over the full range of rotor slip from no-load speed down to stall. In this analysis, a motor portion design with a high value of R2 was used that enabled the EM combo machine to operate with two, 2-pole machines over a wide speed difference between the generator portion and induction motor portion. A low value of rotor resistance can provide a stiffer torque/speed curve, but results in a more limited speed-range (slip-range) of operating stability. For stability of the control system, the induction motor portion can be designed to have a torque/speed curve with a variable, but negative slope by the high value of R2.

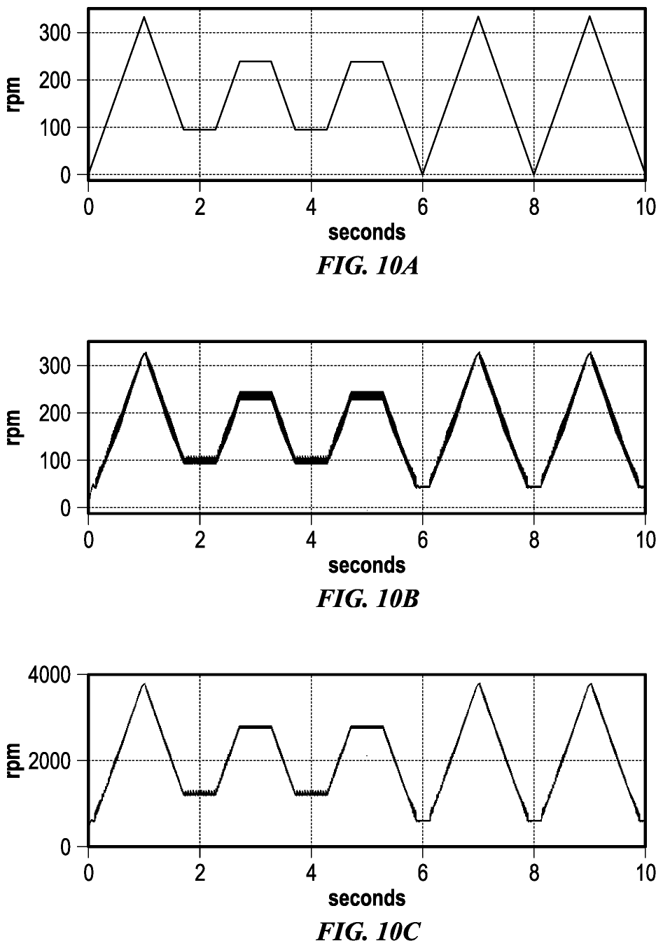

FIG. 10A is a schematic graph of an arbitrary speed demand profile relative to time for the EM combo machine of FIG. 2. FIG. 10B is a simulated schematic graph of an exemplary induction motor portion speed of the EM combo machine following the speed demand profile relative to time of FIG. 10A. FIG. 10C is a simulated schematic graph of an exemplary PM generator portion speed of the EM combo machine with a PM generator portion due to the speed demand profile over time as adjusted for a pole count ratio between the generator portion and the motor portion. The induction motor portion follows the supply frequency but not at 20) synchronous speed, exhibiting some ‘slip’ according to its load torque, as depicted in the above example graph. However, a closed-loop speed control can achieve desired motor speed by adjusting the controlled electrical load with appropriate slip. For example, the control of the speed can be at least partially based on speed input to the controlled electrical load 48 shown in FIG. 2 of a speed error relative to an actual speed of the motor in FIG. 10B and a desired speed shown in FIG. 10A. Similar in concept and not shown by a graph, the control of the motor speed can be at least partially based on positional input to the controlled electrical load 48 of a positional error relative to an actual device position 50 (herein including a portion of the device) and a desired device position.

Operation of Induction Generator Portion with Induction Motor Portion

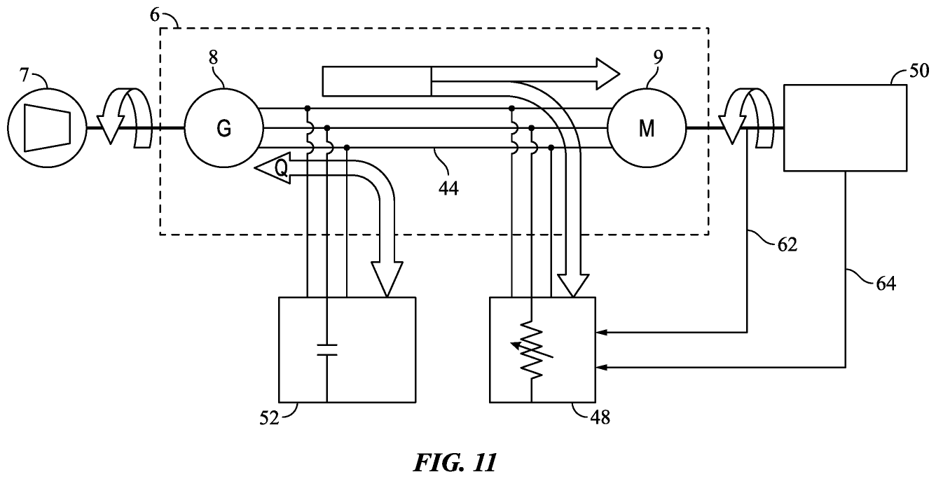

FIG. 11 is a schematic of another example of an EM combo machine having an induction generator portion coupled with an induction motor portion with a controlled electrical load for speed control and/or positional control, and a reactive power source for the induction generator portion. This embodiment is similar to the embodiment described in FIG. 2 but with the turbine 7 fluidicly driven to rotate an induction generator portion 8 to generate power. Through the electrical direct coupling 44, the generated power to the motor portion 9 can enable the motor portion to put into action the device 50. The power to the motor portion can be controlled using speed input 62 and/or positional input 64 to the controlled electrical load 48. A difference from FIG. 2 is that the induction generator portion does not have substantial permanent magnetism. In order to start the generator portion, a small amount of residual magnetism is required in the induction generator portion rotor core. To provide sufficient initial magnetism to “jump start” the induction generator, the EM combo machine 6 can provide one or more capacitors, such as three capacitors for a 3-phase electrical system, placed line-line to form an example of a reactive power source 52 for the magnetizing current of the induction generator portion.

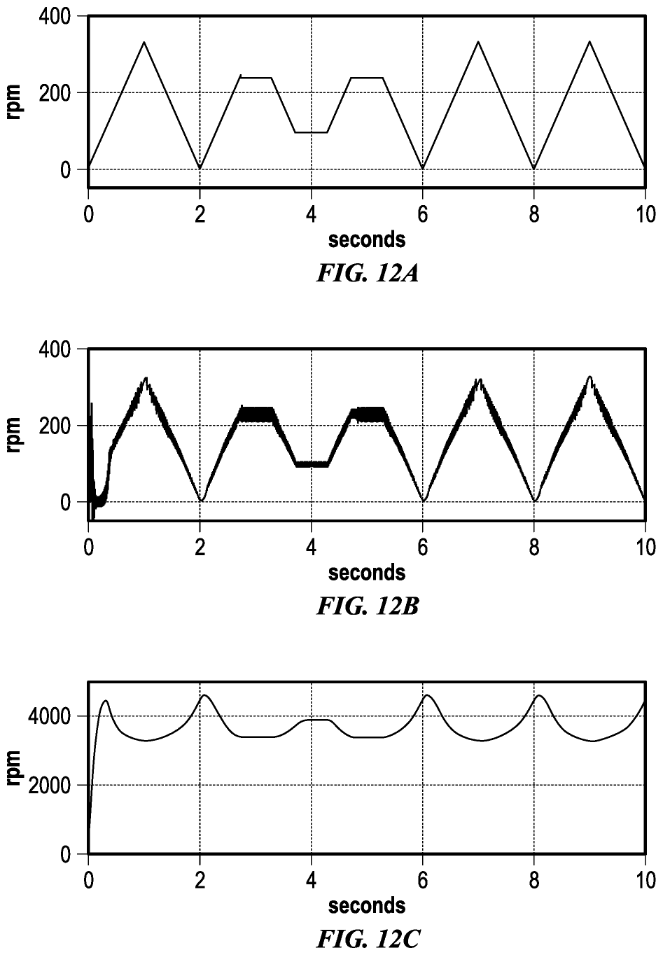

FIG. 12A is a schematic graph of an arbitrary speed demand profile relative to time for the EM combo machine of FIG. 11. FIG. 12B is a simulated schematic graph of an exemplary induction motor portion speed of the EM combo machine of FIG. 11 following the speed demand profile relative to time of FIG. 12A. FIG. 12C is a simulated schematic graph of an exemplary induction generator portion speed of the EM combo machine of FIG. 11, with a stiff torque-speed (slip) characteristic squirrel-cage rotor design of the induction generator portion, with the induction generator portion due to the speed demand profile over time of FIG. 12A, as adjusted for a pole count ratio between the generator portion and the motor portion and with a stiff torque-speed-slip characteristic squirrel-cage rotor design. The performance of such an EM combo machine can be optimized through the selection of the most appropriate torque/speed (slip) characteristic curves for the induction generator portion and induction motor portion, which need not be similar. The selections will affect their relative operating speeds and synchronous frequency in the electrical direct coupling 44 between the induction generator portion and the induction motor portion. These graphs show the response of such an EM combo machine. As in the previous PM generator portion example, the graphs show an arbitrary speed demand profile in FIG. 12A and how the speed of the induction motor portion in FIG. 12B can be made to follow the demand through controlling the controlled electrical load as an additional load on the generator portion. The resulting speed of the generator portion is shown in FIG. 12C. Because of slip, the induction generator speed does not vary as much as the induction motor speed. The actual speed of the motor portion, shown in FIG. 12B, can be adjusted quickly generally in milliseconds or faster to track the demand speed, but the adjustment timing yields a thicker simulated response graph as the speed modulates to the desired speed.

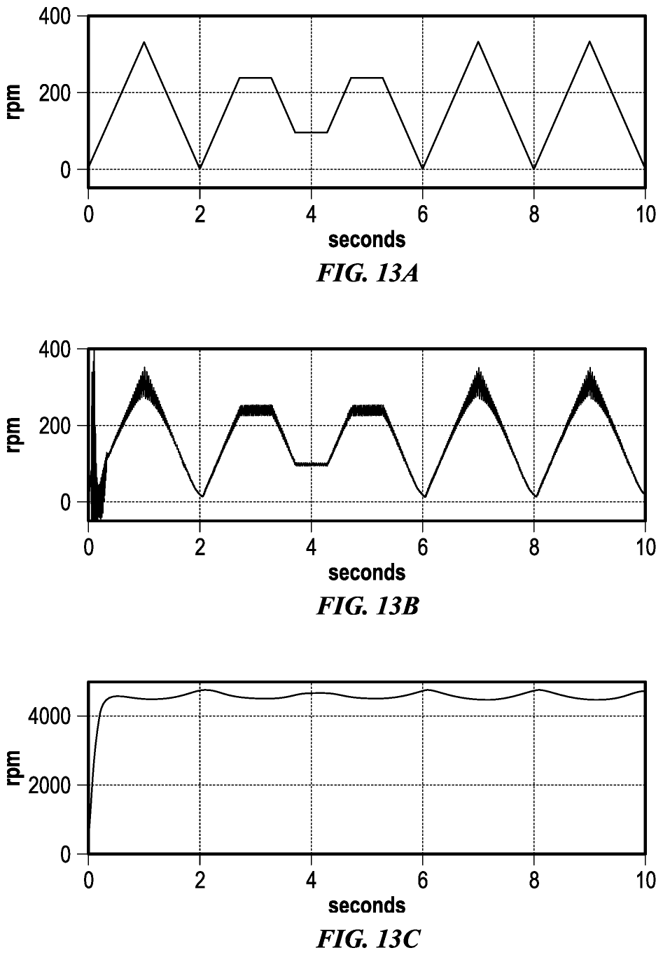

FIG. 13A is a schematic graph of an arbitrary speed demand profile of the EM combo machine relative to time as the same demand profile as in FIG. 12A, but for a less stiff torque-speed characteristic of the induction generator portion. FIG. 13B is a simulated schematic graph of an exemplary induction motor portion speed of the EM combo machine following the speed demand profile relative to time of FIG. 13A. FIG. 13C is a simulated schematic graph of an exemplary induction generator portion speed of the EM combo machine with the induction generator portion due to the speed demand profile over time of FIG. 13A, as adjusted for a pole count ratio between the generator portion and the motor portion with a less-stiff torque-speed-slip characteristic squirrel-cage rotor design. The difference is seen in FIG. 13C where the induction generator portion has less speed variation than the variation shown in FIG. 12C.

The two sets of charts show that the behavior of the induction generator portion speed will differ in its response characteristics according to the specific design of the machine, namely its squirrel-cage rotor design.

### Various EM Combo Machine Embodiments

Combinations of two different flux directions (radial and axial) and a hybrid design are possible depending on the size restrictions and power requirements in the designs of the generator portion and the motor portion. The hybrid design has a rotor magnetic flux element and a stator coil with “L” shape coupling in both the radial and axial directions. A number of the designs are feasible taking into account the bearing layouts and other features. The EM combo machine is possible to use in a mud-lubricated condition such as a drilling environment. For durability, thrust and radial bearings could be made of a PCD (Poly-Crystalline Diamond) or WCo (Tungsten Carbide), or ceramic. If the fluid is clean like freshwater or oil, other materials such as plastic or a metal or a metal-plastic hybrid could be used for bearings. Some examples of embodiments are shown and described.

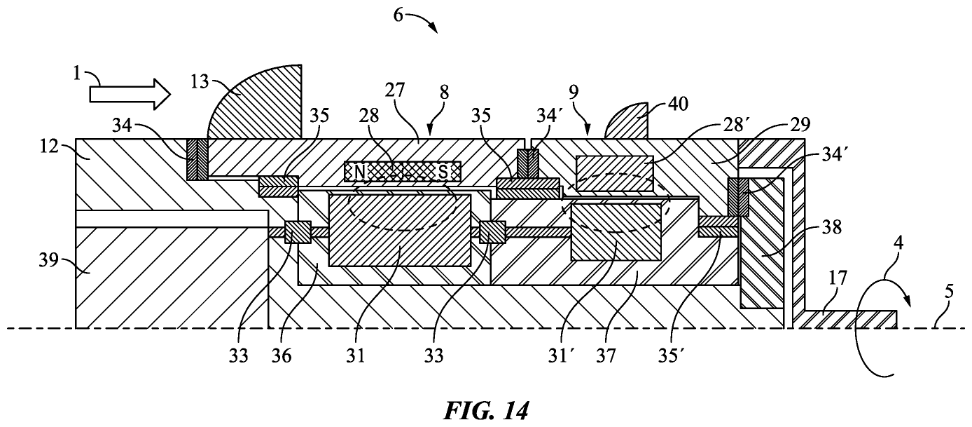

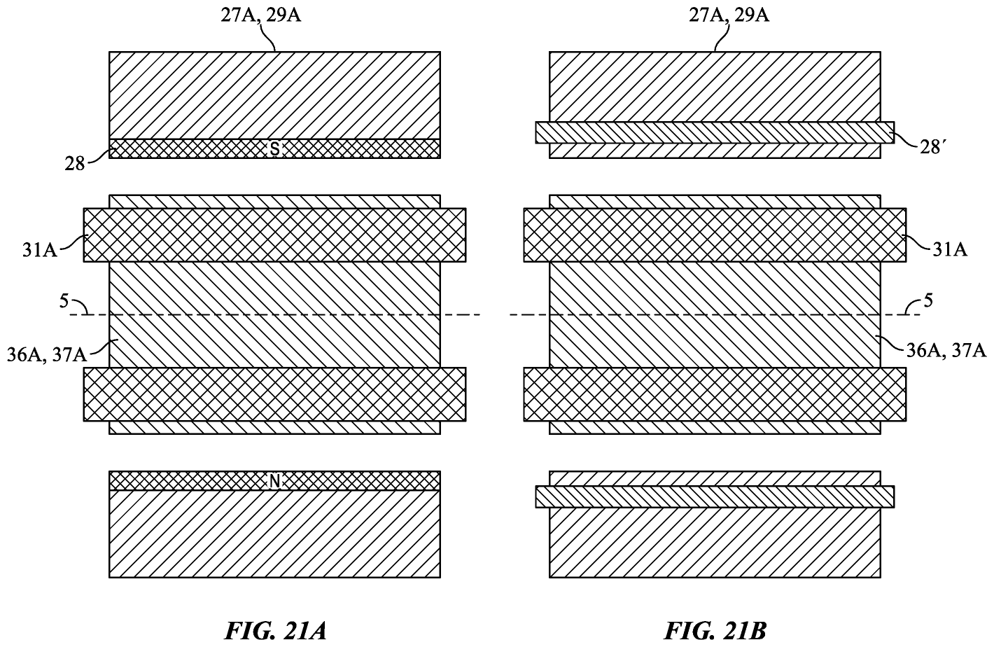

FIG. 14 is a schematic of an embodiment of an EM combo machine having a radial flux oriented generator portion and motor portion. The EM combo machine 6 is shown in an upper half schematic with a lower half schematic (not shown) generally being symmetrical about a longitudinal axis 5. The EM combo machine 6 includes a generator portion 8, such as a radial flux generator portion, as exemplified in FIG. 21A below. A motor portion 9, coupled to equipment (not shown), can be electrically coupled to the generator portion 8. A fluid flow 1 can rotate an impeller 13 coupled with a rotor 27 of a generator portion 8. A stator 36 is disposed radially inward from the rotor, so that the external rotor 27 rotates around the internal stator 36. (An alternative configuration would be an internal rotor that rotates inside an external stator.) A magnetic flux element 28, which is generally a permanent magnet(s) or squirrel cage configuration, can be embedded into the generator portion rotor 27, where in this embodiment the magnetic flux element 28 can be a permanent magnet. The generator portion rotor 27 can be supported with a thrust bearing 34 and radial bearings 35. A mating stator 36 of the generator portion having a stator coil 31 can be disposed radially inward from the rotor 27 and can be coupled to an electronics housing 12 with a smaller diameter. Electrical lines from the stator coil 31 of the stator 36 can be connected to electronics 39 through a bulkhead connector 33.

The motor portion 9 can be located next to the generator portion. A magnetic flux element 28′, such as a squirrel cage, can be embedded into the rotor 29 of the motor portion. The rotor 29 can be connected to a drive shaft 17 that rotates, such as in a counterclockwise direction 4. Thrust bearings 34′ and radial bearings 35 and 35′ can support the rotor 29 of the motor portion. There can be an optional assisting impeller 40 on the rotor 29. The assisting impeller helps rotate the rotor 29 of the motor portion with the fluid flow 1 in a counterclockwise direction. A mating stator 37 with a stator coil 31′ of the motor portion can be located radially inward of the rotor 29, so that the outer rotor 29 rotates around the inner stator 37. An assisting impeller 40 can be coupled to the motor section 9 to help reduce an amount of required electrical power to the motor portion. The stator 37 of the motor portion is also coupled on the electronics housing 12 in a similar manner as the stator 36 of the alternator. Electrical wires are connected to the electronics 39 through a bulkhead 33. The stators 36 and 37 are constrained in the axial direction with a retainer 38.

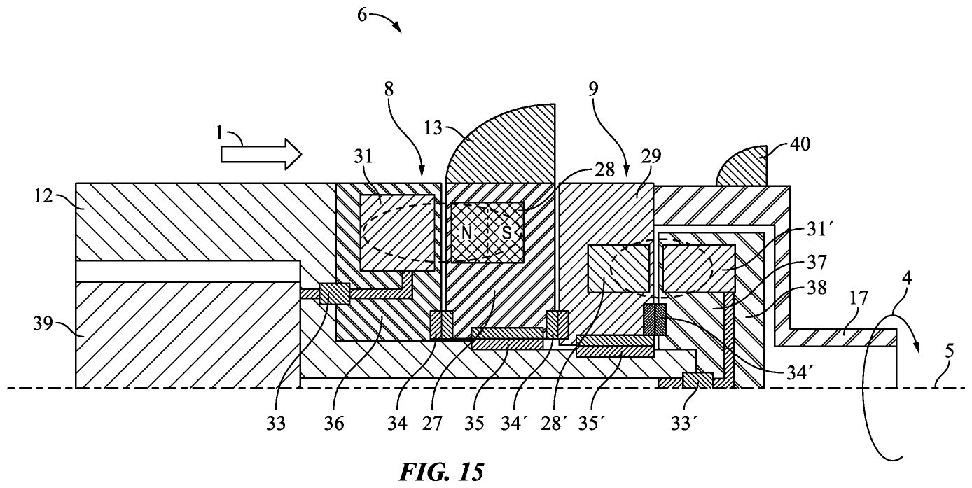

FIG. 15 is a schematic of another embodiment of an EM combo machine having an axial flux generator portion and motor portion. FIG. 15 illustrates an embodiment, shown in an upper half portion about longitudinal axis 5, similar to FIG. 14, but with a flux coupling axially. The electrical lines from the stator coil 31 of a stator 36 of the generator portion 8 can be connected to the electronics 39 through the bulkhead connector 33. The fluid flow 1 rotates an impeller 13 that is coupled with the rotor 27 of the generator portion. The magnetic flux element 28 can be embedded into the generator portion rotor 27. The rotor 27 can be supported with a thrust bearing 34 and a radial bearing 35.

The motor portion 9 can be located adjacent to the generator portion and disposed at a different longitudinal position along a longitudinal axis 5 from the generator portion. The motor portion includes a rotor 29 with a stator 37 longitudinally disposed adjacent to the rotor. A squirrel cage 30 can be embedded into the motor portion rotor 29. The drive shaft 17 can be coupled to the rotor 29. The rotor 29 can be supported with thrust bearings 34′ and a radial bearing 35′. The drive shaft 17 can be rotated, for example, in a counterclockwise direction 4. An optional assisting impeller 40 can be coupled to the drive shaft 17 to assist rotating in the counterclockwise direction 4 with flow 1. The assisting impeller can help reduce the required electrical power to the motor portion. A retainer 38 can hold the assembly axially together. The wires from a stator coil 31′ of a stator 37 of the motor portion 9 can be connected to the electronics 39 through the bulkhead connector 33′.

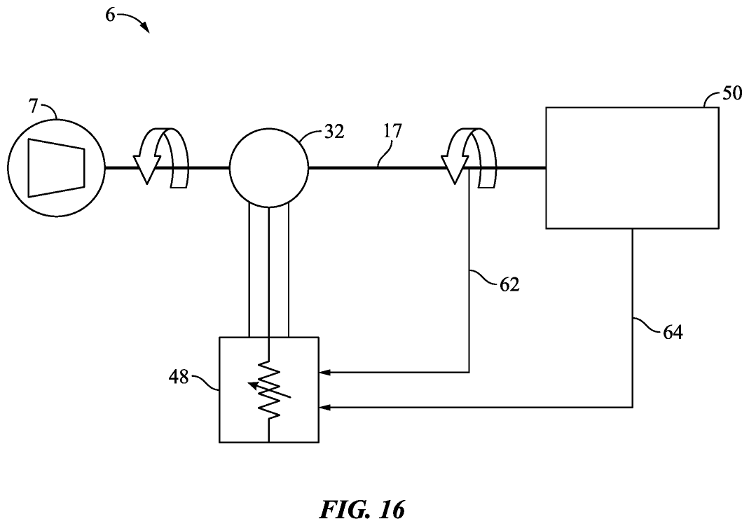

FIG. 16 is a schematic of another example of an EM combo machine having a single-shaft system with permanent magnet generator portion having an output drive shaft of a motor portion to form an EM machine. In general, the EM combo machine 6 includes an EM machine 32 having an integrated function of an electrical power generator portion with an output drive shaft 17 of a motor portion. The EM combo machine 6 can use a low-speed turbine 7 coupled directly to the generator portion of the EM machine 32, which can be configured for low speed. The EM combo machine can also include a controlled electrical load 48 for speed control and/or positional input 64 for positional control. The drive shaft 17 for the device 50 can be generally common (including couplings, joints, and speed reduction equipment) to the generator portion of the EM machine 32 and turbine 7. The drive shaft speed can be controlled by applying an electrical load to the generator portion of the EM machine through the variable controlled electrical load 48 for a variable braking load.

As an example, the generator portion rotational speed in rpm can be lowered to 50 to 400 rpm instead of 1,000 to 2,500 rpm. There are techniques known in the art to construct a low rpm generator portion, such as can used in gearless wind turbines and tidal current turbines. Those sizes are very large, but some power can be generated from about 5 rpm from the turbine. The rpm requirement of the drive shaft in the embodiment can be in a range of 50 to 400 rpm, and be controlled by a braking technique, such as described above with the controlled electrical load.

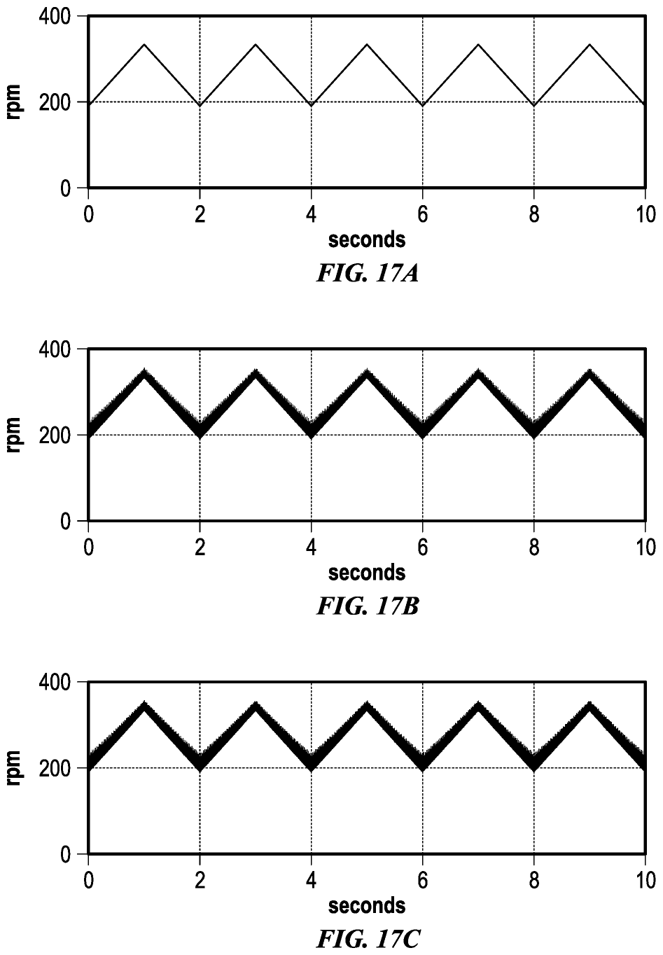

FIG. 17A is a schematic graph of an arbitrary speed demand profile relative to time for the EM machine of FIG. 16. FIG. 17B is a simulated schematic graph of an exemplary drive shaft speed of the EM machine following the speed demand profile relative to time of FIG. 17A. FIG. 17C is a simulated schematic graph of an exemplary PM generator portion speed of the EM machine controlling a variable, resistive braking load, with the generator portion following the speed demand profile over time of FIG. 17A. With the direct coupling of the drive shaft 17, the demand speed, shaft speed, and generator portion speed correspond.

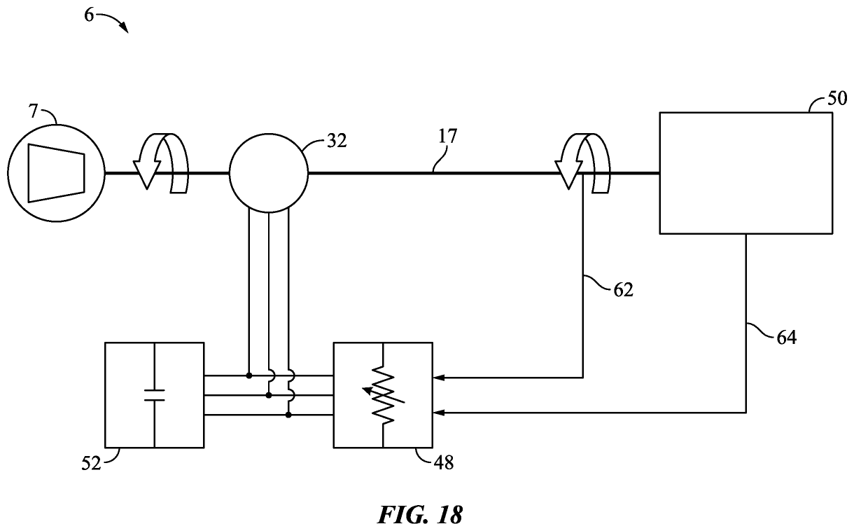

FIG. 18 is a schematic of another embodiment of an EM combo machine similar to the embodiment in FIG. 16 forming an EM machine, but having an induction generator portion. In general, the EM combo machine 6 of this embodiment includes an EM machine 32 having an integrated function of an electrical power generator portion with an output drive shaft 17 of a motor portion. The EM combo machine 6 also provides a reactive power source 52 for the magnetizing current of the induction generator portion. The EM combo machine 6 can use a low-speed turbine 7 coupled directly to the generator portion of the EM machine 32, which can be configured for low speed. The EM combo machine can also include a controlled electrical load 48 for speed control and/or positional input 64 for positional control. The drive shaft 17 for the device 50 can be generally common (including couplings, joints, and speed reduction equipment) to the generator portion of the EM machine 32 and turbine 7. The drive shaft speed can be controlled by applying an electrical load to the generator portion of the EM machine through the variable controlled electrical load 48 for a variable braking load. Like the embodiment in FIG. 16, a schematic graph of an arbitrary speed demand profile relative to time for the EM combo machine could also be represented by FIGS. 17A-17C. With the direct coupling of the drive shaft 17, the demand speed, shaft speed, and generator portion speed correspond.

Depending on the soft-iron lamination material used, residual magnetism may or may not be available in an induction generator portion of FIG. 18 in contrast to the magnetism available with a permanent magnet generator portion of FIG. 16. Alternative methods possibly include:
The addition of a very weak magnet within the rotor, such as a ferrite magnet, that is just sufficient to start the induction generator portion, but still weak enough to not retain or at least minimize attracting iron particles from the mud-flow.
The inclusion of a small pilot PM alternator to provide the magnetizing current to the induction generator portion and also permit the elimination of the line-line capacitors for reactive power.

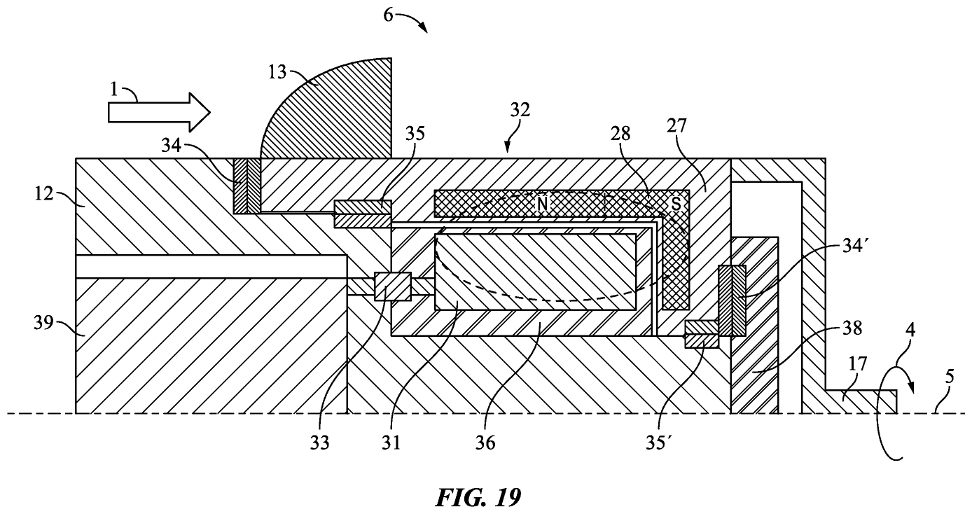

FIG. 19 is a schematic of another embodiment of an EM machine having a low RPM single-shaft system schematically illustrated in FIGS. 16 and 18. This EM combo machine 6 as an EM machine 32 embodiment has an integrated function of an electrical power generator portion with an output drive shaft 17 of a motor portion, shown in an upper half portion about longitudinal axis 5. The EM machine illustrates a simple and compact design consisting of a single pair of the rotor and stator. Also, this embodiment of the EM machine is a hybrid type with “L” shaped magnetic flux element 28 coupling both the radial and axial directions. In this particular configuration, the rotor is external to the stator and rotates around the internal stator. An alternative configuration would be an internal rotor that rotates inside an external stator.

The fluid flow 1 can rotate an impeller 13 that can be coupled to the rotor 27. The magnetic flux element 28 can be embedded in the rotor 27. The drive shaft 17 can be attached on an end of the rotor 27, and can transmit a torque, such as in a counterclockwise direction 4. The rotor 27 can be supported with thrust bearings 34, 34′ and radial bearings 35, 35′. The mating stator 36 can be located radially internal to the rotor 27 and longitudinally disposed in part next to the rotor. The stator 36 can be coupled on a small diameter section of the electronics housing 12. The axial direction of the components is restrained by the retainer 38. The electrical lines from the stator coil 31 can be connected to the electronics 39 through the bulkhead connector 33.

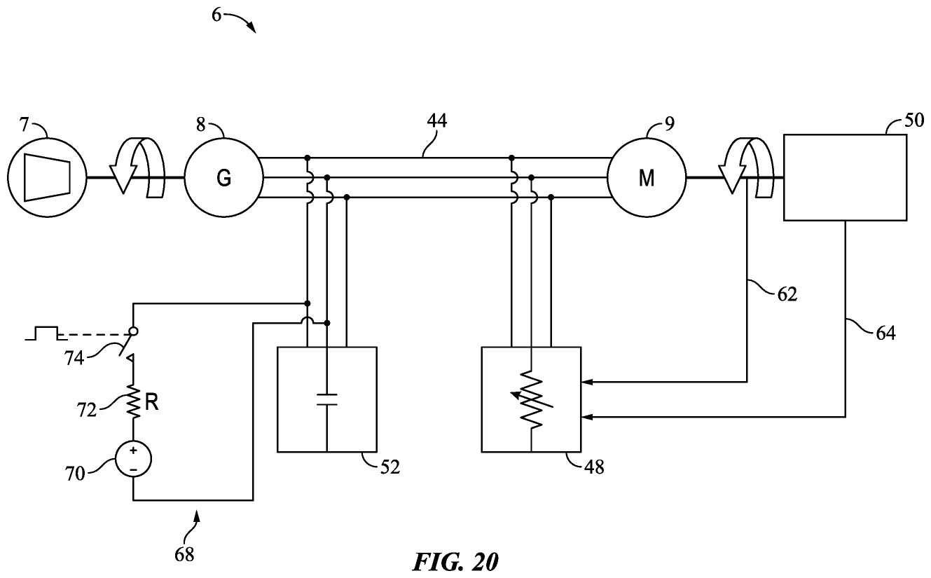

FIG. 20 is a schematic of another example of an EM combo machine having an induction generator portion coupled with an induction motor portion with a controlled electrical load for speed control and/or positional control, a reactive power source, and a starter circuit for the induction generator portion. This embodiment is similar to the embodiment described in FIG. 11 with the turbine 7 fluidicly driven to rotate a generator portion 8 to generate power through the electrical direct coupling 44 to the motor portion 9 to actuate the device 50. The power to the motor portion can be controlled using speed input 62 and/or positional input 64 to the controlled electrical load 48. The EM combo machine 6 can have a reactive power source 52 for a magnetizing current of the inductive generator portion. A difference from FIG. 11 is that the system 6 includes a starter circuit 68 to provide a magnetizing pulse to the generator portion to “jump start” the system, in addition to the reactive power source 52. The starter circuit 68 can include a power source 70, such as a DC power supply, to provide power if the reactive power source 52 has leaked when the EM combo machine is off and can no longer provide an initial pulse. A resistor 72 can be used to control the power flow from the power source 70. A switch 74 can momentarily close to provide a power pulse to the induction generator portion that creates an initial magnetism through the generator portion coils to start the generator portion to generate power when rotated.

FIG. 21A is a schematic of an embodiment of a PM configuration for a generator portion and/or motor portion (or an EM machine having both functions) having a radial flux topology with an external rotor and an internal stator. As shown in FIG. 14, the PM configuration can be formed in a radial configuration around a longitudinal axis 5, in which a radially external rotor 27A of the generator portion can rotate about an outer periphery of a radially internal stator 36A of the generator portion. Similarly, a PM motor portion can also be formed in a radial configuration, in which a radially external rotor 29A of the motor portion can rotate about an outer periphery of a radially internal stator 37A of the motor portion. In this example, a permanent magnet as a magnetic flux element 28 can be coupled to the external rotor 27A or 29A, and a stator coil 31A can be coupled to the internal stator 36A or 37A.

FIG. 21B is a schematic of an embodiment of an induction configuration for a generator portion and/or motor portion (or an EM machine) having a radial flux topology with an external rotor and an internal stator. This embodiment for the induction configuration would be similar to the configuration of FIG. 21A, but without the magnet. The induction configuration can be formed in a radial configuration around a longitudinal axis 5, in which a radially external rotor 27A or 29A can rotate about a radially outer periphery of a radially internal stator 36A or 37A of the generator portion or motor portion. In this example, a squirrel cage, in place of the magnet in FIG. 21A, as a magnetic flux element 28′ can be coupled to the external rotor 27A or 29A, and a stator coil 31A can be coupled to the internal stator 36A or 37A.

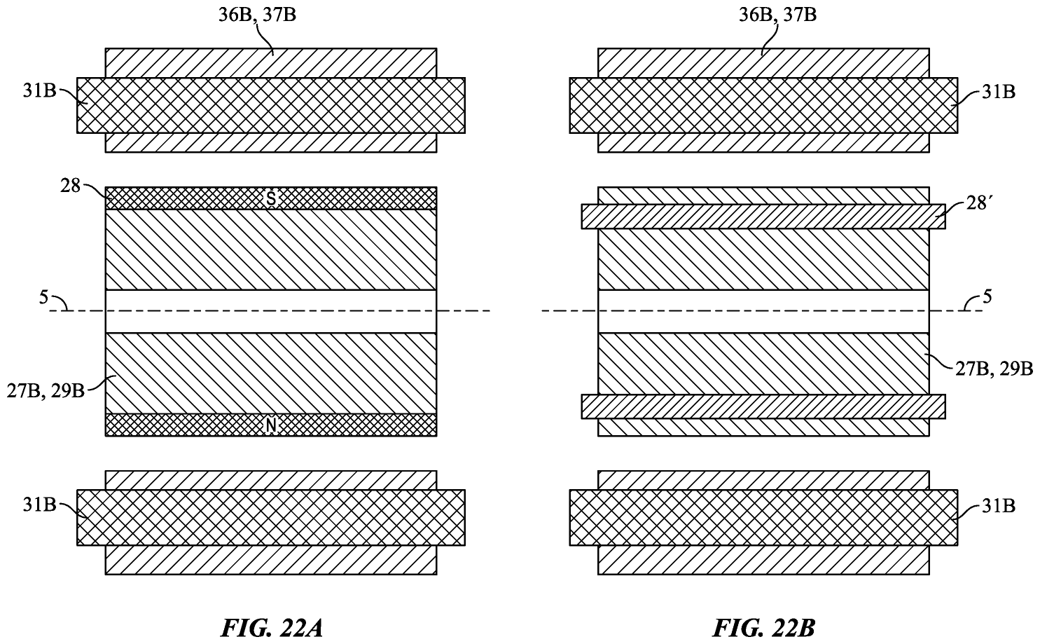

FIG. 22A is a schematic of an embodiment of a PM configuration for a generator portion and/or motor portion (or an EM machine) having a radial flux topology with an internal rotor and an external stator, as an alternative to the external rotor and internal stator configuration in FIGS. 21A and 21B. The PM configuration can be formed in a radial configuration around a longitudinal axis 5, in which a radially internal rotor 27B or 29B with a permanent magnet as a magnetic flux element 28 can rotate within an inner periphery of a radially external stator 36B or 37B of the generator portion or motor portion. In this example, a permanent magnet as a magnetic flux element 28 can be coupled to the internal rotor 27B or 29B, and a stator coil 31B can be coupled to the external stator 36B or 37B.

FIG. 22B is a schematic of an embodiment of an induction configuration for a generator portion and/or motor portion (or an EM machine) having a radial flux topology with an internal rotor and an external stator. This embodiment for the induction configuration would be similar to the configuration of FIG. 22A, but without the magnet. The induction configuration can be formed in a radial configuration around a longitudinal axis 5, in which a radially internal rotor 27B or 29B can rotate within radially inner periphery of a radially external stator 36B or 37B of the generator portion or motor portion. In this example, a squirrel cage, in place of the magnet in FIG. 22A, as a magnetic flux element 28′ can be coupled to the internal rotor 27B or 29B, and a stator coil 31B can be coupled to the external stator 36B or 37B.

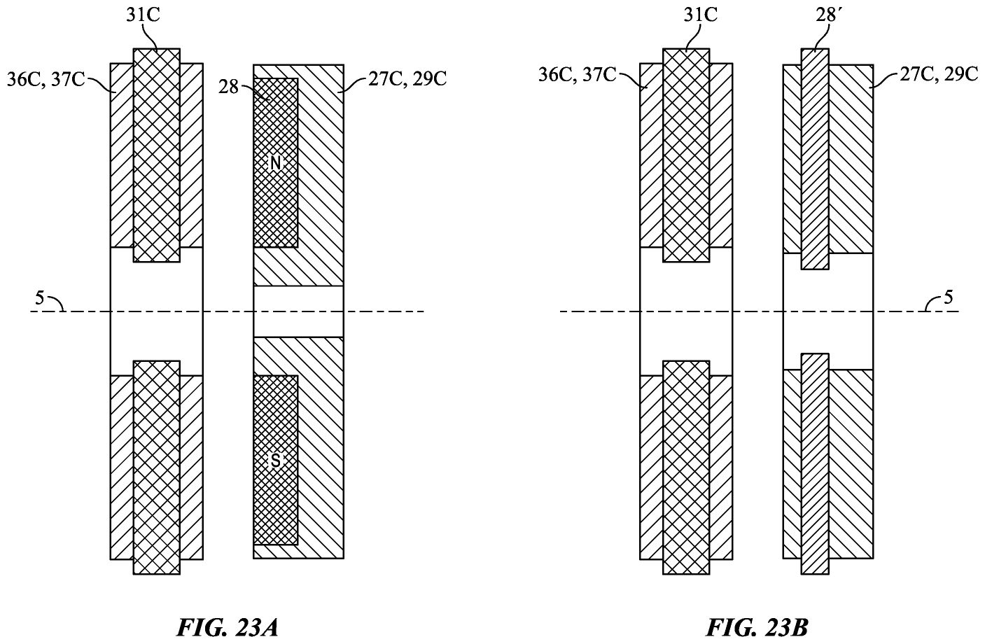

FIG. 23A is a schematic of an embodiment of a PM configuration for a generator portion and/or motor portion (or EM machine) having an axial flux topology with a stator longitudinally adjacent a rotor. The PM configuration can be formed in an axial configuration, in which a rotor 27C or 29C can be disposed at a different longitudinal position along a longitudinal axis 5 from a stator 36C or 37C of the generator portion or motor portion. In this example, a permanent magnet as a magnetic flux element 28 can be coupled to the axial rotor 27C or 29C, and a stator coil 31C can be coupled to the axial stator 36C or 37C.

FIG. 23B is a schematic of an embodiment of an induction configuration for a generator portion and/or motor portion (or EM machine) having an axial flux topology with a stator longitudinally adjacent a rotor. This embodiment for the induction configuration would be similar to the configuration of FIG. 23A, but without the magnet. The induction configuration can be formed in an axial configuration, in which a rotor 27C or 29C can be disposed at a different longitudinal position along a longitudinal axis 5 from a stator 36C or 37C of the generator portion and motor portion. In this example, a squirrel cage, in place of the magnet in FIG. 23A, as a magnetic flux element 28′ can be coupled to the axial rotor 27C or 29C, and a stator coil 31C can be coupled to the axial stator 36B or 37B.

While the EM combo machine has been described in various embodiments, the device is not limited to such embodiments or applications. Different placement of the components in the EM combine device, different couplings, different combinations of axial flux and radial flux embodiments, different numbers of poles and different pole pitches, and other variations are contemplated for the invention, different initial excitations and combinations for the induction generator portion and/or motor portion, and other variations that are limited only by the scope of the claims. Further, the EM combo machine can be equipped with sensors coupled to processors and other devices for actuating, controlling, measuring, or other operational functions, as would be known to those with ordinary skill in the art given the teachings herein.

The invention has been described in the context of preferred and other embodiments, and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope of the following claims.

What is claimed is:

1. An electromagnetic combo machine, comprising:
a generator portion; and
a motor portion electrically directly coupled to the generator portion.

2. The electromagnetic combo machine of claim 1, wherein the generator portion and the motor portion share a stator in a single housing.

3. The electromagnetic combo machine of claim 1, wherein the electromagnetic combo machine is immersed in a flowing conductive fluid and wherein the fluid is allowed to flow through at least one of the electromagnetic combo machine and between a stator and rotor of the electromagnetic combo machine.

4. The electromagnetic combo machine of claim 1, wherein the motor portion is configured for multiple rotational speeds.

5. The electromagnetic combo machine of claim 4, further comprising a variable controlled electrical load coupled to an electrical direct coupling for the motor portion that is electrically directly coupled to the generator portion and configured to absorb excess power from the generator portion to regulate speed of the motor portion.

6. The electromagnetic combo machine of claim 5, wherein the control of the speed is at least partially based on speed input to the controlled electrical load of a speed error relative to an actual speed and a desired speed.

7. The electromagnetic combo machine of claim 5, wherein the control of the speed is at least partially based on positional input to the controlled electrical load of a positional error relative to an actual device position and a desired device position.

8. The electromagnetic combo machine of claim 4, further comprising a controlled electrical load configured to regulate speed of the motor portion.

9. The electromagnetic combo machine of claim 8, wherein the controlled electrical load comprises at least one of a variable resistor and a pulse width modulator.

10. The electromagnetic combo machine of claim 1, further comprising a turbine coupled to the generator portion and configured to rotate from fluid flow through the turbine to rotate a rotor of the generator portion.

11. The electromagnetic combo machine of claim 1, wherein the motor portion comprises an induction motor portion.

12. The electromagnetic combo machine of claim 1, wherein the generator portion comprises a permanent magnet configured to induce an electromagnetic force to create a current in the generator portion.

13. The electromagnetic combo machine of claim 12, wherein the motor portion comprises an induction motor portion.

14. The electromagnetic combo machine of claim 1, wherein the generator portion comprises an induction generator portion.

15. The electromagnetic combo machine of claim 14, wherein the induction generator portion comprises a squirrel cage; and further comprising a reactive power source to start the generator portion.

16. The electromagnetic combo machine of claim 14, wherein the induction generator portion is electrically coupled to a starter circuit having a DC power supply and configured to provide momentary power for initial excitation of the induction generator portion.

17. The electromagnetic combo machine of claim 1, wherein the generator portion and the motor portion have an equal quantity of poles.

18. The electromagnetic combo machine of claim 1, wherein the generator portion and the motor portion have different quantities of poles configured to have different relative no-load rotational speeds between the generator portion and the motor portion.

19. The electromagnetic combo machine of claim 1, wherein the generator portion and the motor portion each comprise an induction configuration having a squirrel cage.

20. The electromagnetic combo machine of claim 1, wherein the electromagnetic combo machine comprises an electromagnetic machine configured to be coupled to a device.

21. The electromagnetic combo machine of claim 20, wherein the electromagnetic machine comprises an induction electromagnetic machine.

22. The electromagnetic combo machine of claim 20, wherein the electromagnetic machine comprises a permanent magnet electromagnetic machine.

23. A method of actuating a device, comprising:
providing power to an electromagnetic combo machine having a generator portion electrically directly coupled to motor portion; and
actuating the device with the electromagnetic combo machine.

24. The method of claim 23, further comprising controlling a speed of the motor portion by a controlled electrical load.

25. The method of claim 23, further comprising controlling a position of the device by a controlled electrical load.

26. The method of claim 23, further comprising providing reactive power to the generator portion for initial excitation.

27. The method of claim 23, wherein providing power to the electromagnetic combo machine comprises passing a fluid by a turbine and rotating a portion of the turbine coupled to a rotor of the generator portion.
